(19) United States
(12) Patent Application Publication
(10) Pub. No.: US 2022/0282006 A1
(43) Pub. Date: Sep. 8, 2022

(54) PROCESS FOR STRIPPING AN AQUEOUS DISPERSION OF POLYMERIC BEADS

(71) Applicants: Dow Global Technologies LLC, Midland, MI (US); Rohm and Haas Company, Collegeville, PA (US)

(72) Inventors: Zhen Qian, Shanghai (CN); Jianming Xu, Shanghai (CN); James C. Bohling, Lansdale, PA (US); Philip R. Harsh, Birdsboro, PA (US)

(73) Assignees: Dow Global Technologies LLC, Midland, MI (US); Rohm and Haas Company, Collegeville, PA (US); Rohm and Haas Company, Collegeville, PA (US)

(21) Appl. No.: 17/634,745

(22) PCT Filed: Sep. 30, 2019
(86) PCT No.: PCT/CN2019/109277

§ 371 Date: Feb. 11, 2022

(51) Int. Cl. C08F 6/00; B01D 19/00; B01D 3/38

(52) U.S. Cl. CPC C08F 6/001; B01D 19/001; B01D 3/38

(57) ABSTRACT

A process of stripping aqueous dispersion of polymeric beads with volatile organic compounds and an aqueous polymer composition obtained by the process.

### FIELD OF THE INVENTION

The present invention relates to a process for stripping an aqueous dispersion of polymeric beads with volatile organic compounds and an aqueous polymer composition obtained therefrom with reduced volatile organic compounds.

### INTRODUCTION

Aqueous dispersions of polymeric beads with large particle size (e.g., >4.5 μm) are useful in compositions that form coatings with a matte (low gloss) finish, for example, as a clear top coat for leather that is smooth to the touch. During preparing these polymeric beads, residual monomers, impurities from monomers, reaction by-products, solvents from surfactants, and/or other raw materials may contribute to volatile organic compounds (“VOCs”) in the resultant aqueous dispersions. The coating industry is always interested in developing coating compositions without or with substantially reduced VOC content for less environmental problems. VOCs also tend to have strong odors and significantly negative impacts on indoor air quality. Steam stripping is one of widely used approaches in removing VOCs from polymer dispersions. For example, U.S. Pat. No. 7,745,567 discloses a process for continuously stripping a polymer dispersion with volatile substances by contacting the dispersion with steam, where strippers comprise a shell and tube heat exchanger or a spiral heat exchanger. Unfortunately, it is found that steam stripping of these polymeric beads is not efficient in removing VOCs, which may due to their much larger particle size than conventional binders. It would therefore be advantageous to discover a process that produces aqueous dispersions of polymeric beads with reduced VOCs, and preferably reduced odor.

### SUMMARY OF THE INVENTION

The present invention provides a process for stripping an aqueous dispersion of polymeric beads with volatile organic compounds. The process of the present invention is efficient in removing VOCs and reducing odor as compared to a process of stripping the aqueous dispersion of polymeric beads alone.

In a first aspect, the present invention is a process for stripping an aqueous dispersion of polymeric beads with volatile organic compounds. The process comprises:

admixing an aqueous dispersion of a film-forming polymer with the aqueous dispersion of polymeric beads with volatile organic compounds to form an admixture, wherein the film-forming polymer has a particle size in the range of from 30 nm to 400 nm, wherein the polymeric beads have a particle size in the range of larger than 4.5 μm to 50 μm, and wherein the weight ratio of the film-forming polymer to the polymeric beads is in the range of from 55:45 to 99:1;

steam stripping the admixture; and

adding a thickener.

In a second aspect, the present invention is an aqueous polymer composition obtained from the process of the first aspect, having a volatile organic compounds content of 800 ppm or less.

### DETAILED DESCRIPTION OF THE INVENTION

“Aqueous” dispersion herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, or mixtures thereof.

“Volatile organic compound” (“VOC”) refers to any organic compound with a normal boiling point less than 250° C.

“Acrylic” in the present invention includes (meth)acrylic acid, alkyl (meth)acrylate, (meth)acrylamide, (meth)acrylonitrile and their modified forms such as hydroxyalkyl (meth)acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

As used herein, the term structural units, also known as polymerized units, of the named monomer refers to the remnant of the monomer after polymerization, or the monomer in polymerized form. For example, a structural unit of methyl methacrylate is as illustrated:

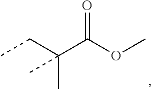

where the dotted lines represent the points of attachment of the structural unit to the polymer backbone.

The process for stripping an aqueous dispersion of polymeric beads with volatile organic compounds comprises admixing an aqueous dispersion of a film-forming polymer (also known as “binder”) with the aqueous dispersion of polymeric beads having VOCs to form an admixture, steam stripping the admixture, and adding a thickener, e.g., prior to steam stripping the admixture, after steam stripping the admixture, or combinations thereof, thus to form an aqueous polymer composition with reduced VOCs.

The film-forming polymer useful in the present invention usually has a particle size in the range of from 30 nanometers (nm) to 400 nm, for example, 40 nm or more, 50 nm or more, 60 nm or more, 70 nm or more, 80 nm or more, or even 90 nm or more, and at the same time, 350 nm or less, 300 nm or less, 250 nm or less, 200 nm or more, or even 150 nm or less. The particle size of the film-forming polymer herein refers to the average particle size as measured by Brookhaven BI-90 Particle Size Analyzer as described in the Examples section below.

The film-forming polymer useful in the present invention may comprise structural units of one or more monoethylenically unsaturated nonionic monomers. As used herein, the term “nonionic monomers” refers to monomers that do not bear an ionic charge between pH=1-14. Suitable monoethylenically unsaturated nonionic monomers may include, for example, alkyl esters of (meth)acrylic acids, vinyl aromatic monomers such as styrene and substituted styrene, vinyl esters of carboxylic acid, ethylenically unsaturated nitriles, or mixtures thereof. Examples of suitable ethylenically unsaturated nonionic monomers include C₁-C₂₀-, C₁-C₁₀-, or C₁-C₈-alkyl esters of (meth)acrylic acids including, for example, methyl acrylate, methyl methacrylate, ethyl acrylate, butyl acrylate, butyl methacrylate, 2-ethylhexyl acrylate, iso-butyl (meth)acrylate, hexyl (meth)acrylate, lauryl (meth)acrylate, stearyl (meth)acrylate, cyclohexyl (meth)acrylate, benzyl(meth)acrylate, oleyl(meth)acrylate, palmityl (meth)acrylate, nonyl(meth)acrylate, decyl (meth)acrylate, dodecyl (meth)acrylate, pentadecyl (meth)acrylate, hexadecyl (meth)acrylate, octadecyl (meth)acrylate, hydroxyethyl (meth)acrylate, or hydroxypropyl (meth)acrylate; acetoacetyl functional monomers such as acetoacetoxyethyl methacrylate (AAEM), acetoacetoxyethyl acrylate, acetoacetoxypropyl (meth)acrylate, allyl acetoacetate, vinyl acetoacetate, acetoacetoxybutyl (meth)acrylate, 2,3-di(acetoacetoxy)propyl (meth)acrylate, and t-butyl acetoacetate; methylacrylamidoethyl ethylene urea; (meth)acrylonitrile; (meth)acrylamide such as acrylamide, methacrylamide, and diacetone acrylamide (DAAM); alkylvinyldialkoxysilane ; vinyltrialkoxysilanes such as vinyltriethoxysilane and vinyltrimethoxysilane; (meth)acryl functional silanes including, for example, (meth)acryloxyalkyltrialkoxysilanes such as gamma-methacryloxypropyltrimethoxysilane and methacryloxypropyltriethoxysilane; 3-methacryloxypropylmethyldimethoxysilane; 3 -methacryloxypropyltrimethoxysilane; 3-methacryloxypropyltriethoxysilane; or mixtures thereof. Preferred monoethylenically unsaturated nonionic monomers for preparing the film-forming polymer are selected from the group consisting of styrene, methyl (meth)acrylate, acetoacetoxyethyl methacrylate, butyl (meth)acrylate, 2-ethyl acrylate, ethyl (meth)acrylate, and acrylonitrile. The film-forming polymer may comprise, by weight based on the weight of the film-forming polymer, from 80% to 100%, from 82% to 99%, from 85% to 98%, or from 90% to 95% of structural units of the monoethylenically unsaturated nonionic monomer.

The film-forming polymer useful in the present invention may further comprise structural units of one or more monoethylenically unsaturated ionic monomer. As used herein, the term “ionic monomers” refers to monomers that bear an ionic charge between pH=1-14. The ionic monomers may include carboxylic acid monomers, phosphorous acid monomers and salts thereof, sulfonic acid monomers and salts thereof, or mixtures thereof. Examples of suitable monoethylenically unsaturated ionic monomers include α,β-ethylenically unsaturated carboxylic acids including an acid-bearing monomer such as methacrylic acid, acrylic acid, itaconic acid, maleic acid, or fumaric acid; or a monomer bearing an acid-forming group which yields or is subsequently convertible to, such an acid group (such as anhydride, (meth)acrylic anhydride, or maleic anhydride; vinyl phosphonic acid, allyl phosphonic acid, phosphoalkyl (meth)acrylates such as phosphoethyl (meth)acrylate, phosphopropyl (meth)acrylate, phosphobutyl (meth)acrylate, or salts thereof; 2-acrylamido-2-methyl-1-propanesulfonic acid; sodium salt of 2-acrylamido-2-methyl-1-propanesulfonic acid; ammonium salt of 2-acrylamido-2-methyl-1-propane sulfonic acid; sodium vinyl sulfonate; sodium salt of allyl ether sulfonate; or mixtures thereof. Preferred monoethylenically unsaturated ionic monomers are selected from the group consisting of acrylic acid, methacrylic acid, phosphoethyl (meth)acrylate, sodium salt of 2-acrylamido-2-methyl-1-propanesulfonic acid, and mixtures thereof. The film-forming polymer may comprise, by weight based on the weight of the film-forming polymer, from 0.1% to 20%, from 0.3% to 10%, from 0.5% to 5%, or from 1% to 3% of structural units of the monoethylenically unsaturated ionic monomer.

The film-forming polymer useful in the present invention may comprise structural units of one or more multiethylenically unsaturated monomers. “Multiethylenically unsaturated monomers” means monomers have two or more ethylenically unsaturated bonds. Examples of suitable multiethylenically unsaturated monomers include allyl (meth)acrylate, hexanediol di(meth)acrylate, ethylene glycol di(meth)acrylate, neopentyl glycol di(meth)acrylate, butanediol di(meth)acrylate, trimethylolpropane tri(meth)acrylate, divinyl benzene, allyl (meth)acrylamide, allyl oxyethyl (meth)acrylate, crotyl (meth)acrylate, diallyl maleate, butylene glycol (1,3) di(meth)acrylate, or mixtures thereof. The film-forming polymer may comprise structural units of the multiethylenically unsaturated monomer in an amount of from zero to 10%, from 0.1% to 5%, from 0.2% to 3%, from 0.3% to 2%, by weight based on the weight of the film-forming polymer. In one embodiment, the film-forming polymer is an acrylic emulsion polymer. “Acrylic emulsion polymer” herein refers to an emulsion polymer comprising structural units of one or more acrylic monomers or their mixtures with other monomers including, for example, styrene or substituted styrene.

Total weight concentration of the monomers for preparing the film-forming polymer is equal to 100%. Types and levels of the monomers described above may be chosen to provide the film-forming polymer with a glass transition temperature (Tg) suitable for different applications, for example, in the range of from −20 to 45° C., from −10 to 40° C., from 0 to 30° C., or from 10 to 25° C. Tg may be measured by Differential Scanning Calorimetry (DSC) as described in the Examples section below.

The aqueous dispersion of the film-forming polymer useful in the present invention may have a minimum film formation temperature (MFFT) in the range of from −20 to 50° C., from −10 to 40° C., or from −5 to 20° C., as determined by the test method described in the Examples section.

The film-forming polymer useful in the present invention may be prepared by emulsion polymerization, typically in the presence of one or more surfactants. The surfactants may be added prior to or during the polymerization of the monomers, or combinations thereof. A portion of the surfactant can also be added after the polymerization. The surfactants may include anionic and/or nonionic emulsifiers such as, for example, alkali metal or ammonium salts of alkyl, aryl, or alkylaryl sulfates, sulfonates or phosphates; alkyl sulfonic acids; sulfosuccinate salts; fatty acids; polymerizable surfactants; and ethoxylated alcohols or phenols. The surfactant used is usually from 0.5% to 5%, preferably from 0.8% to 2%, by weight based on the weight of total monomers. Temperature suitable for emulsion polymerization processes may be lower than 100° C., in the range of from 30° C. to 95° C., or in the range of from 50° C. to 90° C. Multistage free-radical polymerization can also be used in preparing the film-forming polymer, which at least two stages are formed sequentially, and usually results in the formation of the multistage polymer comprising at least two polymer compositions.

In the emulsion polymerization, free radical initiators may be used. The polymerization process may be thermally initiated or redox initiated emulsion polymerization. Examples of suitable free radical initiators include hydrogen peroxide, t-butyl hydroperoxide, cumene hydroperoxide, ammonium and/or alkali metal persulfates, sodium perborate, perphosphoric acid, and salts thereof; potassium permanganate, and ammonium or alkali metal salts of peroxydisulfuric acid. The free radical initiators may be used typically at a level of 0.01 to 3.0% by weight, based on the total weight of monomers. Redox systems comprising the above described initiators coupled with a suitable reductant may be used in the polymerization process.

Examples of suitable reductants include sodium formaldehyde sulfoxylate, ascorbic acid, isoascorbic acid, alkali metal and ammonium salts of sulfur-containing acids, such as sodium sulfite, bisulfite, thiosulfate, hydrosulfite, sulfide, hydrosulfide or dithionite, formadinesulfinic acid, acetone bisulfite, glycolic acid, hydroxymethanesulfonic acid, glyoxylic acid hydrate, lactic acid, glyceric acid, malic acid, tartaric acid and salts of the preceding acids. Metal salts of iron, copper, manganese, silver, platinum, vanadium, nickel, chromium, palladium, or cobalt may be used to catalyze the redox reaction. Chelating agents for the metals may optionally be used.

In the emulsion polymerization, a chain transfer agent may be used. Examples of suitable chain transfer agents include 3-mercaptopropionic acid, n-dodecyl mercaptan, methyl 3-mercaptopropionate, butyl 3-mercaptopropionate, benzenethiol, azelaic alkyl mercaptan, or mixtures thereof. The chain transfer agent may be used in an amount of from zero to 1%, from 0.1% to 0.7%, or from 0.2% to 0.5%, by weight based on the total weight of monomers.

After completing the emulsion polymerization, the obtained aqueous dispersion of the film-forming polymer may be neutralized by one or more bases as neutralizers to a pH value, for example, at least 6, from 6 to 10, or from 7 to 9. Examples of suitable bases include ammonia; alkali metal or alkaline earth metal compounds such as sodium hydroxide, potassium hydroxide, calcium hydroxide, zinc oxide, magnesium oxide, sodium carbonate, or mixtures thereof.

The aqueous dispersion of polymeric beads useful in the present invention may be formed by methods known in the art such as, for example, seeded growth process or suspension polymerization process, preferably seeded growth process such as those described in U.S. Pat. No. 4,530,956. Such polymeric beads are described, for example, in U.S. Pat. Nos. 4,403,003, 7,768,602, 7,829,626, and 9,155,549. The aqueous dispersion of polymeric beads may be prepared by a process comprising the step of contacting, under polymerization conditions, an aqueous dispersion of first microspheres with first stage monomers to grow out the first microspheres to form the aqueous dispersion of polymeric beads.

The first microspheres useful for preparing the polymeric beads preferably comprises from 90% to 99.9% of structural units of one or more monoethylenically unsaturated nonionic monomers. The monoethylenically unsaturated nonionic monomers may include those described in the film-forming polymer section above. Examples of suitable monoethylenically unsaturated nonionic monomers include acrylates such as ethyl acrylate, butyl acrylate, and 2-ethylhexyl acrylate; methacrylates such as methyl methacrylate, n-butyl methacrylate, t-butyl methacrylate, hydroxyethyl methacrylate, hydroxypropyl methacrylate, acetoacetoxyethyl methacrylate and uredio methacrylate; acrylonitrile; acrylamides such as acrylamide and diacetone acrylamide; styrene; and vinyl esters such as vinyl acetate. Although it is possible for the first microspheres to include structural units of carboxylic acid monomers such as methacrylic acid or acrylic acid, it is preferred that the first microspheres comprise less than 5%, less than 3%, or even less than 1% of structural units of a carboxylic acid monomer, by weight based on the weight of the first microspheres. The first microspheres more preferably comprise structural units of acrylate or methacrylates or combinations of acrylates and methacrylates. The first microspheres useful for preparing the polymeric beads are advantageously prepared from an aqueous dispersion of an oligomeric seed having a weight average molecular weight (Mw) in the range of 800 grams per mole (g/mol) or more, 1,000 g/mol or more, or even 1,500 g/mol or more, and at the same time, 20,000 g/mol or less, 10,000 g/mol or less, or even 5,000 g/mol or less, as determined by size exclusion chromatography using polystyrene standards as described herein. The oligomeric seed may have an average diameter in the range of 200 nm or more, 400 nm or more, or even 600 nm or more, and at the same time, 8,000 nm or less, 5,000 nm or less, 1,500 nm or less, or even 1,000 nm or less, as measured using a Disc Centrifuge Photosedimentometer (DCP) as described in the Examples section below.

The oligomeric seed useful for preparing the polymeric beads contains structural units of a chain transfer agent such as those described in the film-forming polymer section above.

Particularly, suitable chain transfer agents include an alkyl mercaptan, examples of which include n-dodecyl mercaptan, 1-hexanethiol, 1-octane thiol, and 2-butyl mercaptan. The oligomeric seed is advantageously contacted with a first monoethylenically unsaturated nonionic monomer in the presence of a hydrophobic initiator, in any order, to transport the initiator into the seed, or seed swollen with monomer. As used herein, a hydrophobic initiator refers to an initiator having a water solubility in the range of 5 ppm or more, or 10 ppm or more, and at the same time, 10,000 ppm or less, 1,000 ppm or less, or even 100 ppm or less. Examples of suitable hydrophobic initiators include t-amyl peroxy-2-ethyl hexanoate (water solubility=17.6 mg/L at 20° C.), t-butyl peroxy-2-ethylhexanoate (water solubility=46 mg/L at 20° C.), or mixtures thereof. The extent of swelling (seed growth) can be controlled by the ratio of the monomer to the seed. Examples of suitable first monoethylenically unsaturated nonionic monomers include acrylates such as ethyl acrylate, butyl acrylate, and 2-ethylhexyl acrylate; methacrylates such as methyl methacrylate, b-butyl methacrylate, t-butyl methacrylate, hydroxyethyl methacrylate, hydroxypropyl methacrylate, acetoacetoxyethyl methacrylate, and ureido methacrylate; acrylonitrile; acrylamides such as acrylamide and diacetone acrylamide; styrene; and vinyl esters such as vinyl acetate. Forming microspheres from oligomeric seed provides an effective way of controlling the particle size distribution of the microspheres. Preferably, the coefficient of variation of the first microspheres and the polymeric beads, as determined by DCP, is less than 25%, less than 20%, less than 15%, and or even less than 10%. Preferably, the particle size of the first microspheres is in the range of 3.5 μm or more, 4.0 μm or more, 4.5 μm or more, 5.0 μm or more, or even 5.5 μm or more, and at the same time, 20 μm or less, 18 μm or less, 15 μm or less, 12 μm or less, or even 10 μm or less.

The aqueous dispersion of the first microspheres is contacted under polymerization conditions and in the presence of an emulsifying surfactant, such as a phosphate or an alkyl benzene sulfonate or sulfate, with first stage monomers comprising, by weight based on the weight of the first stage monomers, a polymerizable organic phosphate or a salt thereof in an amount of 0.05% or more, 0.1% or more, or even 0.2% or more, and at the same time, 5% or less, 3% or less, or even 2% or less; and a second monoethylenically unsaturated nonionic monomer in an amount of 70% or more, 80% or more, or even 90% or more, and at the same time, 99.95% or less or 99.8% or less. The first microspheres increase in volume (grow out) to form the aqueous dispersion of polymeric beads.

The first stage monomer preferably further comprises a multiethylenically unsaturated nonionic monomer, preferably at a concentration in the range of 0.1% or more, 1% or more, or even 2% or more, and at the same time, 15% or less, 10% or less, or even 8% or less, by weight based on the weight of first stage monomers. The multiethylenically unsaturated nonionic monomers may include those described above in the film-forming polymer section above. Particularly, suitable multiethylenically unsaturated nonionic monomers may include allyl methacrylate, allyl acrylate, divinyl benzene, trimethyolopropane trimethacrylate, trimethylolpropane triacrylate, butylene glycol (1,3) dimethacrylate, butylene glycol (1,3) diacrylate, ethylene glycol dimethacrylate. The inclusion of these multiethylenically unsaturated nonionic monomers is particularly preferred where further staging of the polymeric beads is desired.

The first stage monomer as well as the polymeric beads preferably comprises a substantial absence of structural units of a carboxylic acid monomer. As used herein, a substantial absence of structural units of a carboxylic acid monomer means less than 5%, less than 3%, less than 1%, or even less than 0.2% of structural units of a carboxylic acid monomer such as methacrylic acid or acrylic acid, by weight based on the weight of the polymeric beads.

The polymeric beads useful in the present invention preferably comprise from 90% to 98% structural units of one or more second monoethylenically unsaturated nonionic monomers, which may be the same as or different from the first monoethylenically unsaturated nonionic monomer, by weight based on the weight of the polymeric beads. The polymeric beads useful in the present invention may have a dry density in the range of from 1.01 to 1.10 gram per cubic centimeter (g/cm³), from 1.02 to 1.09 g/cm³, from 1.03 to 1.08 g/cm³, as determined by the test method described in the Examples section below.

The polymeric beads in the present invention may have a particle size in the range of more than 4.5 μm to 50 μm, for example, 4.6 μm or more, 4.7 μm or more, 4.8 μm or more, 4.9 μm or more, 5 μm or more, 5.5 μm or more, 6 μm or more, or even 6.5 μm or more, and at the same time, 50 μm or less, 45 μm or less, 40 μm or less, 35 μm or less, 30 μm or less, 25 μm or less, 22.5 μm or less, 20 μm or lower, 17.5 μm or less, 15 μm or less, 12.5 μm or less, or even 10 μm or less. Particle size as referenced to beads refers to median weight average (D50) particle size as determined by DCP as described in the Examples section below.

The aqueous dispersion of the film-forming polymer and the aqueous dispersion of polymeric beads can be mixed to form the admixture at a weight ratio of the film-forming polymer to the polymeric beads in the range of 55:45 to 99:1, from 55.5:44.5 to 98:2, from 56:44 to 97:3, from 56.5:43.5 to 96:4, from 57:43 to 95:5, from 58:42 to 94:6, from 59:41 to 93.5:6.5, from 60:40 to 93:7, from 62.5:37.5 to 92.5:7.5, from 65:35 to 92:8, from 67.5:32.5 to 91.5:8.5, from 70:30 to 91:9, from 75:35 to 90.5:9.5, from 80:20 to 90:10, or from 80:20 to 85:15. Preferably, the weight ratio of the film-forming polymer to the polymeric beads is in the range of from 60:40 to 90:10, and more preferably from 70:30 to 90:10. Prior to mixing, the aqueous dispersion of the film-forming polymer and the aqueous dispersion of polymeric beads may be firstly each independently subject to stream stripping according to conditions described below.

After mixing the aqueous dispersion of the film-forming polymer and the aqueous dispersion of the polymeric beads, the resulting admixture is then subjected to steam stripping.

Process for steam stripping polymer dispersions are known in the art such as those described in U.S. Pat. Nos. 8,211,987 and 7,745,567. The steam stripping can be a continuous process or a batch process. The steam stripping can contact the steam and the admixture in one or multiple points. Contacting of the steam and the admixture can be in a co-current or counter-current mode for a continuous process. Or the steam may contact the admixture in a batch configuration. The batch process typically requires contacting steam from <1 hour up to 6 hours. Both continuous and batch processes are designed to eliminate VOCs in the admixture. In one continuous embodiment, the admixture contacts the steam twice in a co-current mode. Steam stripping the admixture can be conducted by,

feeding the admixture and steam into a stripper under vacuum or under atmospheric pressure;

removing at least a portion of the volatile organic compounds from the admixture;

transferring the portion of the volatile organic compounds to the steam; and

separating the steam from the admixture.

A single stripper or multiple strippers may be used in the step of steam stripping. The admixture and steam may be contacted before the stripper(s) or in the stripper(s). They may be fed to the one or more strippers together or separately. The stripper useful in the present invention can be a single stage continuous stripper using a jacket pipe, a counter-current column, or a packed column. Preferred strippers are continuous designs where small amounts of the admixture contact the steam. Contact time between the admixture and steam in these types of strippers is short.

Prior to feeding the admixture to the stripper, the admixture may be preheated to a temperature in the range of from 30° C. to 70° C. or from 40° C. to 60° C. In one embodiment, the admixture is fed into the stripper at a temperature greater than the water vapor temperature for the stripper pressure.

After the stripper, the admixture and steam may enter a separator vessel. This vessel is used to separate the steam vapor from the resulting liquid composition. The VOCs partition between the admixture and the steam. The resulting aqueous polymer composition with reduced VOCs comprising the film-forming polymer and the polymeric beads are pumped out of the separator vessel. The steam vapor and VOCs are then condensed in a heat exchanger or condenser and the condensate is collected in a receiver tank.

Furthermore, steam stripping may be conducted under vacuum. The pressure in the vacuum may range from 100 to 101,000 Pa (aka atmospheric pressure). The steam loading for the process can vary from 5% of the admixture to >100% of the admixture. Process variants with lower loadings of steam that affect the same amount of VOC separation are more efficient. Here loading of steam is the mass of steam required per mass of the admixture. In a continuous process the ratio of flow rates of steam to the admixture can be used to determine the loading.

The steam stripping process temperature may be set by the vacuum pressure of the system. The temperature may be in the range of from 20° C. to 100° C., preferably from 30° C. to 60° C. Some strippers are jacketed to minimize condensation of the steam into the admixture. The stripper jacket temperature is usually set higher than or equal to the temperature in the stripper to minimize these heat losses and ensures the flow of steam in and out of the process is the same. This maintains the solids level in the admixture.

The process of the present invention further comprises addition of one or more thickeners. The addition of the thickener may be conducted prior to steam stripping of the admixture, after steam stripping of the admixture, or both prior to and after steam stripping of the admixture. The thickener may be added into the aqueous dispersion of the film-forming polymer, the aqueous dispersion of polymeric beads, or both the film-forming polymer and polymeric beads dispersions before steam stripping of the admixture. Preferably, the thickener is added after steam stripping of the admixture of the film-forming polymer and polymeric beads dispersions. “Thickener”, also known as “rheology modifier”, herein refers to a substance which can increase the viscosity of a liquid without substantially changing its other properties. The thickeners may be selected from associative, partially associative, and non-associative thickeners, and mixtures thereof. Suitable non-associative thickeners may include water-soluble/water-swellable thickeners and associative thickeners. Suitable non-associative, water-soluble/water-swellable thickeners may include polyvinyl alcohol (PVA), alkali soluble or alkali swellable emulsions known in the art as ASE emulsions, and cellulosic thickeners such as hydroxyalkyl celluloses including methyl cellulose ethers, hydroxymethyl cellulose (HMC), hydroxyethyl cellulose (HEC), and 2-hydroxypropyl cellulose, sodium carboxymethyl cellulose (SCMC), sodium carboxymethyl 2-hydroxyethyl cellulose, sodium carboxymethyl cellulose, 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, 2-hydoxypropyl cellulose, starches, modified starches, and mixtures thereof. Suitable non-associative thickeners may include inorganic thickeners such as fumed silica, clay materials (such as attapugite, bentonite, laponite), titanates and mixtures thereof. Suitable partially associative thickeners include hydrophobically-modified, alkali-soluble emulsions known in the art as hydrophobically modified alkali swellable emulsion (HASE) emulsions, hydrophobically-modified cellulosics such as hydrophobically-modified hydroxyethyl cellulose (HMHEC), hydrophobically-modified polyacrylamides, and mixtures thereof. Associative thickeners may include hydrophobically-modified ethylene oxide-urethane polymers known in the art as HEUR thickeners. The thickener may be present, by dry weight based on the total weight of the film-forming polymer and the polymeric beads (both in dry weight), in an amount of 0.1% or more, 0.2% or more, 0.3% or more, 0.4% or more, 0.5% or more, 0.6% or more, 0.7% or more, 0.8% or more, 0.9% or more, or even 1.0% or more, and at the same time, 5.0% or less, 4.8% or less, 4.5% or less, 4.2% or less, 4.0% or less, 3.8% or less, 3.5% or less, 3.2% or less, 3.0% or less, 2.8% or less, 2.5% or less, 2.2% or less, or even 2.0% or less.

The process of the present invention is useful in reducing volatile organic compounds in the aqueous dispersion of polymeric beads. As compared to steam stripping the dispersion of polymeric beads alone, the process of the present invention involving steam stripping the admixture of the aqueous dispersions of the film-forming polymer and the polymeric beads shows higher efficiency in reducing VOCs. For example, the process of the present invention can provide VOCs reduction of 15% or more, 18% or more, 20% or more, 25% or more, 30% or more, 35% or more, 40% or more, 45% or more, or even 50% or more, as compared to separately steam stripping the same amount of the aqueous dispersion of the film-forming polymer and the aqueous dispersion of the polymeric beads. VOCs may be measured by GB 18582-2008 test method as described in the Examples section below. The process of the present invention is also useful in decreasing odor, for example, the aqueous polymer composition obtained from the process has less odor as compared to the composition obtained by separately steam stripping the same amount of the aqueous dispersion of the film-forming polymer and the aqueous dispersion of the polymeric beads.

The present invention also relates to an aqueous polymer composition obtained from the process, comprising the film-forming polymer, the polymeric beads, and the thickener, wherein the aqueous polymer composition has low VOCs and/or reduced odor, for example, a VOC content of 800 ppm (parts per million) or less, 750 ppm or less, 700 ppm or less, 650 ppm or less, 600 ppm or less, 550 ppm or less, or even 500 ppm or less, as measured according to the test method described in the Examples section below.

The aqueous polymer composition of the present invention is useful in coating applications, especially where a matte finish is desired, such as marine protective coatings, general industrial finishes, metal protective coatings, automotive coatings, traffic paints, Exterior Insulation and Finish Systems (EIFS), wood coatings, coil coatings, plastic coatings, can coatings, leather coatings, architectural coatings, industrial coatings, and civil engineering coatings. The present invention also provides a method of producing a coating on a substrate, comprising: providing an aqueous polymer composition, applying the substrate the aqueous polymer composition, and drying, or allowing to dry, the applied aqueous polymer composition.

### EXAMPLES

Some embodiments of the invention will now be described in the following Examples, wherein all parts and percentages are by weight unless otherwise specified.

Ethyl acrylate (EA), methacrylic acid (MAA), methyl methacrylate (MMA), acetoacetoxyethyl methacrylate (AAEM), and acrylic acid (AA) are all available from The Dow Chemical Company.

Disponil Fes 32 IS surfactant (Fes 32), available from BASF, is sodium fatty alcohol ether sulfate.

ACRYSOL™ ASE-60 thickener (ASE-60) (28% solids), available from Dow Chemical Company, is an alkali-soluble emulsion type thickener (ACRYSOL is a trademark of The Dow Chemical Company).

The following process, and standard analytical equipment and methods are used in the Examples.

### Solids Content Measurement

Solids content was measured by weighing 0.7±0.1 g of an aqueous dispersion sample (wet weight of the sample is denoted as “W1”), putting into an aluminum pan (weight of aluminum pan is denoted as “W2”) in an oven at 150° C. for 25 min, and then cooling the aluminum pan with the dried sample and weighing a total weight denoted as “W3”. Solids content of the sample is calculated by (W3−W2)/W1*100%.

### Particle Size Measurement for Film-Forming Polymer

The particle size of a film-forming polymer was measured by using Brookhaven BI-90 Plus Particle Size Analyzer, which employs the technique of photon correlation spectroscopy (light scatter of sample particles). This method involved diluting 2 drops of an aqueous dispersion of the film-forming polymer to be tested in 20 mL of 0.01 M sodium chloride (NaCl) solution, and further diluting the resultant mixture in a sample cuvette to achieve a desired count rate (K) (e.g., K ranging from 250 to 500 counts/sec for diameter in the range of 10-300 nm). Then the particle size of the film-forming polymer was measured and reported as a Z-average diameter by intensity.

### DCP Particle Sizing Methods for Acrylic Oligomer Seed, First Microspheres and Polymeric Beads

Particle sizes and distribution were measured using a Disc Centrifuge Photosedimentometer (DCP, CPS Instruments, Inc., Prairieville, La.) that separates modes by centrifugation and sedimentation through a sucrose gradient. The samples were prepared by adding 1 to 2 drops of the oligomer seed dispersion into 10 mL of deionized (DI) water containing 0.1% sodium lauryl sulfate, followed by injection of 0.1 mL of the sample into a spinning disc filled with 15 g/mL of sucrose gradient. For the oligomer seed, a 0-4% sucrose gradient disc spinning at 10,000 revolutions per minute (rpm) was used, and a 596-nm polystyrene calibration standard was injected prior to injection of the sample. For the microspheres, a 2-8% sucrose gradient disc spinning at 3,000 rpm was used, and 9-μm polystyrene calibration standard was injected prior to injection of the sample. Median weight average (D50) particle size and coefficient of variation (CV) were calculated using instrument's algorithm.

### Dry Density of Polymeric Beads

An aqueous dispersion of polymeric beads sample was measured for wet density (D1) and solids content (S), respectively. Then the dry density of the polymeric beads, D (g/cm³), is calculated according to the below equation,

$$D = S / ( ( \frac{1}{D 1} ) - \frac{1 - S}{D 2} ) ,$$

where D1 is the wet density of the aqueous dispersion of polymeric beads at 25° C. (g/cm³); S is the solids content of the aqueous dispersion of polymeric beads; and D2 is the density of water at 25° C. (g/cm³); where D1 and D2 were measured according to ASTM D 1475: 2013 (Standard Test Method for Density of Liquid Coatings, Inks, and Related Products).

### Differential Scanning Calorimetry (DSC)

DSC was used to measure Tgs. A 5-10 milligram (mg) sample was analyzed in a sealed aluminum pan on a TA Instrument DSC Q2000 fitted with an RCS (refrigerator cooling system) cooling accessory and an auto-sampler under a nitrogen (N₂) atmosphere at a gas flow of 50 ml/minute (min). Tg measurement was conducted with three cycles including, from −85 to 280° C. at a rate of 10° C./min followed by holding for 5 min (1^{st} cycle), from 280 to −85° C. at a rate of 10° C./min (2^{nd} cycle), and from −85 to 280° C. at a rate of 10° C./min (3^{rd} cycle). Tg was obtained from the 3^{rd} cycle by half height method.

### MFFT

The minimum film-forming temperature (MFFT) of an aqueous dispersion of a film-forming polymer is the lowest temperature at which it will uniformly coalesce when laid on a substrate as a thin film by using a MFFT-BAR, according to ASTM D 2354-10 (2018).

### VOCs Measurement

VOCs were measured according to GB 18582-2008 national standard (Indoor decorating and refurbishing materials-Limit of harmful substances of interior architectural coatings), where acetonitrile was used as the solvent and a mass spectrometer detector was used.

### In-cCn Odor Test

In-can odor was rated on a scale of 1-10, 10 is the best and 1 is the worst. An aqueous solution of butanol (0.2%) was used as a benchmark sample for the odor score of 0. DI water was used as a benchmark sample for the odor score of 10. Odor panelists smell the two benchmark samples first before evaluation of the odor of each test sample. Then odor panelists smell each test sample for around 20-30 seconds, and then rated and recorded the score of the odor. 8-10 panelists evaluated the odor for each test sample and the average value of the odor scores rated by all the panelists was reported.

### Steam Stripping Process

The steam stripping process used in the examples below was conducted in a single stage, continuous stripper for two cycles with polymer dispersion flow rate: 500 g/min, steam flow rate: 75 g/min, jacket temperature: 49° C., oven pressure: 6 kpa, and steam stripping tower aperture: 1 inch (2.54 cm).

### Preparation of an Aqueous Dispersion of Polymeric Beads

An aqueous dispersion of acrylic oligomer seed (33% solids content, 67 butyl acrylate/18 n-dodecyl mercaptan/14.8 methyl methacrylate/0.2 methacrylic acid) with a weight average median particle size (D50) of 885 nm and a coefficient of variation of 5%, as determined by DCP, and a weight average molecular weight of 2,532 g/mol was prepared as described in U.S. Pat. No. 9,155,549, from column 4, line 25 “A. Preparation of Pre-Seed” to column 5, line 20.

Initiator emulsion was prepared by combining in a separate vial DI water (4.9 g), Rhodacal DS-4 branched alkylbenzene sulfonate from Solvay (DS-4, 0.21 g, 22.5% aq. solution), 4-hydroxy 2,2,6,6-tetramethylpiperidine (4-hydroxy TEMPO, 0.4 g, 5% solution), t-amyl peroxy-2-ethylhexanoate (TAPEH, 5.42 g, 98% active), then emulsified for 10 min with a homogenizer at 15000 rpm. The initiator emulsion was then added to the dispersion of the acrylic oligomer seed (4.2 g, 32% solids) in a separate vial and mixed for 60 min. A shot monomer emulsion (shot ME) was prepared in a separate flask by combining DI water (109.5 g), Solvay Sipomer PAM-200 phosphate esters of PPG monomethacrylate from Solvay (PAM-200, 1.3 g, 97% active), DS-4 (4.13 g, 22.5% solution), 4-hydroxy TEMPO (0.2 g, 5% solution), n-butyl acrylate (BA, 251.5 g) and allyl methacrylate (ALMA, 10.5 g). DI water (1575 g) was added to a 5-L round bottom flask (reactor) fitted with a stirrer, condenser, and a temperature probe. The reactor was heated to 70° C., after which time the initiator and oligomer seed mixture was added to the reactor, and shot ME was fed into the reactor over 15 min. After an induction period of 30 min, the resultant exotherm caused the reactor temperature to rise to 80° C. The particle size of the microspheres formed in this step was measured by DCP was 4.9 μm.

A first monomer emulsion (ME1, prepared by combining DI water (328.5 g), PAM-200 (3.9 g), DS-4 (12.38 g, 22.5% solution), 4-hydroxy TEMPO (0.6 g, 5% solution), BA (754.5g), and ALMA (31.5 g) was then fed into the reactor over 55 min. After a 20-min hold, NH₄OH (1.35 g, 28% aqueous solution) was fed into the reactor over 3 min. The particle size of the microspheres formed in this step as measured by DCP was 8.3 μm.

The reactor temperature was cooled to and maintained at 75° C., after which time FeSO_{4.}7H₂O (11 g, 0.15% aqueous solution) and EDTA tetrasodium salt (2g, 1% aqueous solution) were mixed and added to reactor. A second monomer emulsion (ME2) was prepared in a separate flask by combining DI water (90 g), DS-4 (3.2 g, 22.5% solution), methyl methacrylate (MMA, 254 g) and ethyl acrylate (EA, 10.9 g). ME2, t-butyl hydroperoxide solution (t-BHP, 1.44 g 70% aqueous solution in 100 g water) and isoascorbic acid (IAA, 1.44 g in 100 g water) was fed into the reactor over 45 min. The residual monomers were then chased by feeding t-BHP solution (2.54 g 70% aqueous solution in 40 g water) and IAA (1.28 g in 40 g water) into reactor over 20 min. The consequent dispersion was filtered through a 45 μm screen; gel that remained on the screen was collected and dried (270 ppm). The filtrate was analyzed for percent solids (33.2%), coefficient of variation (7.9%) and particle size (8.4 μm, as measured by DCP). The obtained polymeric beads had a dry density of 1.076 g/cm³.

### Preparation of an Aqueous Dispersion of a Film-Forming Polymer (“Binder”)

A monomer emulsion was prepared by mixing DI water (450 g), Fes 32 (37.7 g, 31% solution), MMA (445.5 g), EA (1042.6 g), MAA (23.76 g), and AAEM (56.3 g). In a 5-liter, four necked round bottom flask equipped with a paddle stirrer, a thermometer, nitrogen inlet and a reflux condenser, DI water (710 g) was added and heated to 90° C. under nitrogen atmosphere with stirring. Disponil LDBS 19 IS surfactant sodium dodecyl (Linear) benzene sulfonate from BASF (LDBS, 12.11 g, 19% solution), Na₂CO₃ (3.82 g), and 58.5 g of the monomer emulsion were then added into the flask, quickly followed by sodium persulfate (5.35 g) dissolved in DI water (19.5 g). Upon holding the batch for 1 min with stirring, the remaining monomer emulsion was added into the flask while co-feeding 5.35 g of sodium persulfate catalyst and 1.34 g of sodium bisulfite activator solution in 90 min. When the monomer emulsion feed was completed, t-BHP (1.53 g, 70% aqueous solution) and IAA (0.47 g) were added, and then another catalyst/activator feed (8.03 g 70% aqueous solution of t-BHP in 2.72 g IAA) was added to the flask in 40 min to chase the residual monomer. Then ammonia was added to adjust pH to 7.5-8.5. The obtained aqueous dispersion (i.e., binder) had a MFFT of 3° C. and a solids content of about 47% by weight. The film-forming polymer in the aqueous dispersion had a Tg of 15° C. as measured by DSC test method described above and an average particle size of about 140 nm as measured by Brookhaven BI-90 Plus Particle Size Analyzer.

### Comparative Example (Comp Ex) A1

The aqueous dispersion of polymeric beads prepared above was evaluated for VOCs content.

### Comp Ex A2

The aqueous dispersion of polymeric beads prepared above was packed in a barrel and then held in an oven at 50° C. for 0.5 day before steam stripping. Steam stripping the aqueous dispersion of polymeric beads was then conducted according to the conditions described in the stream stripping process above.

### Comp Ex A3

The binder prepared above was packed in a barrel and then held in an oven at 50° C. for 0.5 day before steam stripping. Steam stripping the binder was then conducted according to the conditions described in the stream stripping process above.

### Comp Ex B1

The binder and the aqueous dispersion of polymeric beads prepared above, respectively, were packed in barrels and then held in an oven at 50° C. for 0.5 day before steam stripping. The binder and the dispersion of polymeric beads were further subject to steam stripping according to the conditions described in the stream stripping process above, respectively, and then the resultant two dispersions obtained from steam stripping were mixed at a dry weight ratio of binder to polymeric beads of 50:50. Then 0.5% by dry weight of ASE-60 thickener was added into the obtained mixture, based on the total dry weight of the film-forming polymer and the polymeric beads, to form an aqueous polymer composition.

### Comp Ex B2

To a 5-liter four necked round bottom flask equipped with a paddle stirrer, a thermometer and a reflux condenser, the as prepared binder was added. Then the dispersion of polymeric beads obtained above was added into the flask slowly at room temperature. The dry weight ratio of the binder to the polymeric beads was 50:50. The obtained admixture was stirred slowly for 1 hour, packed in a barrel, and then held in an oven at 50° C. for 0.5 day before steam stripping. The admixture was then subjected to steam stripping according to the conditions described in the stream stripping process above. After steam stripping, 0.5% by dry weight of ASE-60 thickener was added into the resultant dispersion, based on the total dry weight of the film-forming polymer and the polymeric beads, to form an aqueous polymer composition.

### Ex 1

To a 5-liter four necked round bottom flask equipped with a paddle stirrer, a thermometer and a reflux condenser, the as prepared binder was added. Then the dispersion of polymeric beads obtained above was added into the flask slowly at room temperature. The dry weight ratio of the binder to the polymeric beads was 90:10. The obtained admixture was stirred slowly for 1 hour, packed in a barrel, and then held in an oven at 50° C. for 0.5 day before steam stripping. The admixture was then subjected to steam stripping according to the conditions described in the stream stripping process above. After steam stripping, 0.5% by dry weight of ASE-60 thickener was added into the resultant dispersion, based on the total dry weight of the film-forming polymer and the polymeric beads, to form an aqueous polymer composition.

### Comp Ex C1

Comp Ex C1 was conducted as in Comp Ex B1, except the dry weight ratio of binder to polymeric beads was 90:10.

### Ex 2

Ex 2 was conducted as in Ex 1, except the dry weight ratio of binder to polymeric beads was 70:30.

### Comp Ex C2

Comp Ex C2 was conducted as in Comp Ex B1, except the dry weight ratio of binder to polymeric beads was 70:30.

### Ex 3

Ex 3 was conducted as in Ex 1, except the dry weight ratio of binder to polymeric beads was 60:40.

### Comp Ex C3

Comp Ex C3 was conducted as in Comp Ex B1, except the dry weight ratio of binder to polymeric beads was 60:40.

### Ex 4

Ex 4 was conducted as in Ex 1, except the dry weight ratio of binder to polymeric beads was 55:45.

### Comp Ex C4

Comp Ex C4 was conducted as in Comp Ex B1, except the dry weight ratio of binder to polymeric beads was 55:45.

### Comp Ex D1

Comp Ex D1 was conducted as in Comp Ex B1, except the dry weight ratio of binder to polymeric beads was 20:80.

### Comp Ex D2

Comp Ex D2 was conducted as in Comp Ex B2, except the dry weight ratio of the binder to polymeric beads was 20:80.

The aqueous polymer compositions obtained above were evaluated for VOCs and in-can odor properties according to the test methods described above and results are given in Table 1. As shown in Table 1, VOCs in pure polymeric beads were difficult to be removed by steam stripping. The dispersion of polymeric beads (without steam stripping) contained about 2000 ppm VOCs (Comp Ex A1). Two cycles of steam stripping of the dispersion of polymeric beads alone only removed about 10% of VOCs (Comp Ex A2). Steam stripping the aqueous polymer composition comprising the admixture of the binder and polymeric beads at a dry weight ratio of 50:50 (Comp Ex B2) or 20:80 (Comp Ex D2) didn't show significant decrease of total VOCs (e.g., less than 10% decrease), as compared to steam stripping the binder and the polymeric beads separately, e.g., Comp Ex B1 and Comp Ex D1, respectively. In contrast, steam stripping the aqueous polymer composition comprising the admixture of the binder and polymeric beads at a dry weight ratio of 90:10 (Ex 1) decreased more than 50% total VOCs of those in Comp Ex C1. Steam stripping the composition comprising the admixture of the binder and polymeric beads at a dry weight ratio of 70:30 (Ex 2) decreased more than 40% of total VOCs of those in Comp Ex C2 Steam stripping the composition comprising the admixture of the binder and polymeric beads at a dry weight ratio of 60:40 (Ex 3) or at a dry weight ratio of 55:45 (Ex 4) decreased more than 30% of total VOCs of those in Comp Exs C3 and C4, respectively.

In summary, steam stripping of admixture of polymeric beads and binders can improve the efficiency of reducing total VOCs as compared to steam stripping the dispersion of polymeric beads alone (Comp Ex A2).

As shown in Table 2, steam stripping of the polymeric beads only was difficult to improve in-can odor (only 2 for Comp Ex A2). By steam stripping the admixture of the binder and polymeric beads at a dry weight ratio of 90:10, the in-can odor of the resultant aqueous composition of Ex 1 was improved to around 8.5, as compared to the in-can odor rating being around 7.5 when cold blending stream stripped binder and steam stripped polymeric beads at a weight ratio of 90:10 (Comp Ex C1). The in-can odor of the aqueous composition of Ex 2 was also improved as compared to the aqueous composition of Comp Ex C2 obtained by cold blending stream stripped binder and steam stripped polymeric beads. Therefore, steam stripping the admixture of polymeric beads and binders (Exs 1-4) shows synergy effects in reducing in-can odor as compared to cold blends of stream stripped polymeric beads and steam stripped binder.

TABLE 1
VOCs and in-can odor properties

| | | Total | In- |
|---|---|---|---|
| | Binder/Polymeric beads (dry weight | VOCs | can |
| | ratio of Binder/Polymeric beads) | (ppm) | Odor |
| Comp Ex A1 | Aqueous dispersion of polymeric beads | 2043 | NA |
| | (without steam stripping) | | |
| Comp Ex A2 | Aqueous dispersion of polymeric beads | 1833 | 2 |
| | (with steam stripping) | | |
| Comp Ex A3 | Steam stripped Binder | 389 | 8 |
| Comp Ex B1 | Steam stripped Binder plus steam stripped | 1111 | 6 |
| | Polymeric beads (50:50) | | |
| Comp Ex B2 | Steam stripped admixture of [Binder + | 1030 | 7 |
| | Polymeric beads (50:50)] | | |
| Ex 1 | Steam stripped admixture of [Binder + | 248 | 8.5 |
| | Polymeric beads (90:10)] | | |
| Comp Ex C1 | Steam stripped Binder plus steam stripped | 533 | 7.5 |
| | Polymeric beads (90:10) | | |
| Ex 2 | Steam stripped admixture of [Binder + | 484 | 8.25 |
| | Polymeric beads (70:30)] | | |
| Comp Ex C2 | Steam stripped Binder plus steam stripped | 822 | 7 |
| | Polymeric beads (70:30)] | | |
| Ex 3 | Steam stripped admixture of [Binder + | 622 | 7.5 |
| | Polymeric beads (60:40)] | | |
| Comp Ex C3 | Steam stripped Binder plus steam stripped | 967 | NA |
| | Polymeric beads (60:40)] | | |
| Ex 4 | Steam stripped admixture of [Binder + | 698 | 7.5 |
| | Polymeric beads (55:45)] | | |
| Comp Ex C4 | Steam stripped Binder plus steam stripped | 1039 | NA |
| | Polymeric beads (55:45)] | | |
| Comp Ex D1 | Steam stripped Binder plus steam stripped | 1544 | 4 |
| | Polymeric beads (20:80) | | |
| Comp Ex D2 | Steam stripped admixture of [Binder + | 1435 | 4 |
| | Polymeric beads (20:80)] | | |

*Dry weight ratio of binder/polymeric beads, also referring to weight ratio of film-forming polymer to polymeric beads. “Dry weight” refers to the weight after drying a sample in an oven at 150° C. for 25 minutes.

What is claimed is:

1. A process for stripping an aqueous dispersion of polymeric beads with volatile organic compounds, comprising:
admixing an aqueous dispersion of a film-forming polymer with the aqueous dispersion of polymeric beads with volatile organic compounds to form an admixture, wherein the film-forming polymer has a particle size in the range of from 30 nm to 400 nm, wherein the polymeric beads have a particle size in the range of larger than 4.5 μm to 50 μm, and wherein the weight ratio of the film-forming polymer to the polymeric beads is in the range of from 55:45 to 99:1;
steam stripping the admixture; and
adding a thickener.

2. The process of claim 1, wherein the polymeric beads have a dry density in the range of from 1.01 to 1.10 g/cm³.

3. The process of claim 1, wherein the polymeric beads have a particle size of from 4.6 to 25 μm.

4. The process of claim 1, wherein the thickener is present in an amount of from 0.1% to 5%, by dry weight based the total weight of the film-forming polymer and the polymeric beads.

5. The process of claim 1, wherein the thickener is selected from the group consisting of associative thickeners, partially associative thickeners, non-associative thickeners, and mixtures thereof.

6. The process of claim 1, wherein the film-forming polymer has a minimum film formation temperature in the range of from −10 to 40° C.

7. The process of claim 1, wherein the polymeric beads comprise less than 5% of structural units of a carboxylic acid monomer, by weight based on the weight of the polymeric beads.

8. The process of claim 1, wherein the weight ratio of the film-forming polymer to the polymeric beads is in the range of 60:40 to 90:10.

9. The process of claim 1, wherein steam stripping is a continuous or batch process.

10. The process of claim 1, wherein steam stripping the admixture is conducted by feeding the admixture and steam into a stripper under vacuum or under atmospheric pressure;
removing at least a portion of the volatile organic compounds from the admixture;
transferring the portion of the volatile organic compounds to the steam; and
separating the steam from the admixture.

11. The process of claim 1, wherein the thickener is added prior to steam stripping the admixture, after steam stripping the admixture, or combinations thereof.

12. An aqueous polymer composition obtained from the process of claim 1, having a volatile organic compounds content of 800 ppm or less.
